(19) United States
(12) Patent Application Publication
(10) Pub. No.: US 2008/0074864 A1
(43) Pub. Date: Mar. 27, 2008

(54) Tornado-Machine - A mist whirling apparatus that can be used as an ornamental display of light, as an air humidifier and as an aerosol generator

(76) Inventor: Stephan Molders, Neu-Eichenberg (DE)

Correspondence Address: DR. STEPHAN MOLDERS, AM WASSERTURM 1, NEU-EICHENBERG, 37249, DE

(21) Appl. No.: 11/694,553

(22) Filed: Mar. 30, 2007

(30) Foreign Application Priority Data
Mar. 30, 2006 (DE) 10 2006 014 734.0

(51) Int. Cl. F24F 6/00; F21V 33/00

(52) U.S. Cl. 362/101; 261/79.2

(57) ABSTRACT

The novelty of the present invention lies in the first-time combination of three technical principles in order to generate an ornamental display of light in the shape of a tornado, that features the additional benefits of being an air humidifier and an aerosol generator as well. The three technical principles are: Usage of fluid motion as eye-catcher, vortex generation, ultrasonic mist generation.

### CROSS-REFERENCE TO RELATED APPLICATIONS

The invention is based on the patent application with the “Aktenzeichen 10 2006 014 734.0”, filed at the German Patent and Trademark Office (DPMA) by the same inventor Dr. Stephan Mölders, priority date Mar. 30^{th} 2006. Title of the invention: “Die Tornadomaschine—Ein Nebel-Wirbler, der als Effektgerät, Luftbefeuchter und Aerosolgenerator einsetzbar ist.”

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Endeavour

The invention strives to create an ornamental display of light in the shape of a tornado, and to add useful functions to the display device. Usually, ornamental lighting fixtures such as lava lamps, bubble pillars, electric discharge globes etc. do not serve a purpose other than being decorative. The present invention is a decorative lighting fixture, but also serves as air humidifier and as aerosol generator. The described functional combination and the simplicity of its design allows the invention to be used as household appliance in the domestic field, but also is applicable in offices, schools, lounges and in show business.

2. References to the state of technology

Inventors early created ornamental lighting fixtures that employed the motion of fluids as eye-catcher, for example U.S. Pat. Nos. 1,856,098 and 3,570,156.

Since the invention of ultrasonic nebulization of liquids, ultrasonic devices are utilized manifold, for example in aerosol generators for inhalation as well as in chemical reactors, in room climate conditioners and the like. For reference see U.S. Pat. Nos. 3,387,607; 3,989,042 and 4,159,803.

Vortex generators are in common use since the advent of technology, for example in carburetors, combustion chambers, separators, chemical reactors, exhaust removal devices etc. For reference, see U.S. Pat. Nos. 4,120,456 (carburetion); 4,606,822 (separation); 2,745,250 (combustion); 3,633,887 (chemical reaction); U.S. Pat. No. 6,632,132; Japanese Pat. Nos. JP002001027434AA; JP000063267855AA (exhaust removal).

The three technical principles mentioned above, illuminated ornamental fluid motion, ultrasonic mist generation and vortex generation, on one hand are being constantly specialized, in order to create more visual appealing effects, to provide aerosols with narrower distribution functions, or to provide better material separation results. For reference, see for example U.S. Pat. Nos. 5,096,467; 6,241,359; 6,481,128; 6,935,760. On the other hand, the principle designs are being diversified and become more and more intertwined. For example, in U.S. Pat. No. 6,536,910, a lighting fixture with an integrated vaporizer is disclosed. In U.S. Pat. Nos. 3,711,698 and 6,676,271 a humidifier is combined with illumination means. In U.S. Pat. No. 6,883,724, the inventor explains, how ultrasonic mist generators are combined with a vortex chamber in order to produce high volume streams of highly selective aerosol particles. U.S. Pat. No. 7,086,823, finally, tells us how to extract energy from the atmosphere with a giant vortex generator.

Even though the complexity of the inventions has increased with the date of application, all three technical principles mentioned above have not been combined in one patent application in the way it is described in the present invention.

### BRIEF SUMMARY OF THE INVENTION

The invention describes a device for generating an ornamental display of light in the shape of a tornado that features the additional benefits of being an air humidifier and aerosol generator. A mist-whirl is created in a see-through whirl chamber by means of an ultrasonic mist generator dipped in a liquid, and a fan. The fan propels air into the whirl chamber by means of a specially designed air inlet that distributes the inflowing air evenly across the whole whirl chamber walls. The whirl is used to evaporate the droplets in the mist very efficiently and it transports aerosols out of the whirl chamber very efficiently as well. The mist-whirl is illuminated by means of continuous or flashed beams of white or colored light for decoration.

The described functions achieved by this invention combined with its simplicity makes it ideal for indoor use at home. With demineralized water, the Tornado-Machine can be used year-round as decorative and interesting eye-catcher. During the winter, its use will moisturize dry heated air. By adding sea salt, ethereal oils and colloidal silver to the water, a sea-like climate with anti-bacterial effect may be generated that helps preventing and curing colds. Larger versions of the machine are equally suited to be placed in offices, schools, lounges and malls. Even larger, walkable versions of the machine, are suited as attraction in business and show business.

### BRIEF DESCRIPTION OF THE SEVERAL VIEWS OF THE DRAWING

FIG. 1: Side-view cross sections along line B-B in FIG. 2 of the mist whirl apparatus according to this invention.

FIG. 2: Top-view cross section of the mist whirl apparatus along line A-A in FIG. 1.

FIG. 3: Top-view cross section of a mist whirl apparatus with a variable air intake.

FIG. 4: Side-view cross section of a different embodiment of a mist whirl apparatus.

FIG. 5: schematic view of an automatic refill station for the mist whirl apparatus.

FIG. 6: Examples of feasible shapes for the whirl chamber

### DETAILED DESCRIPTION OF THE INVENTION

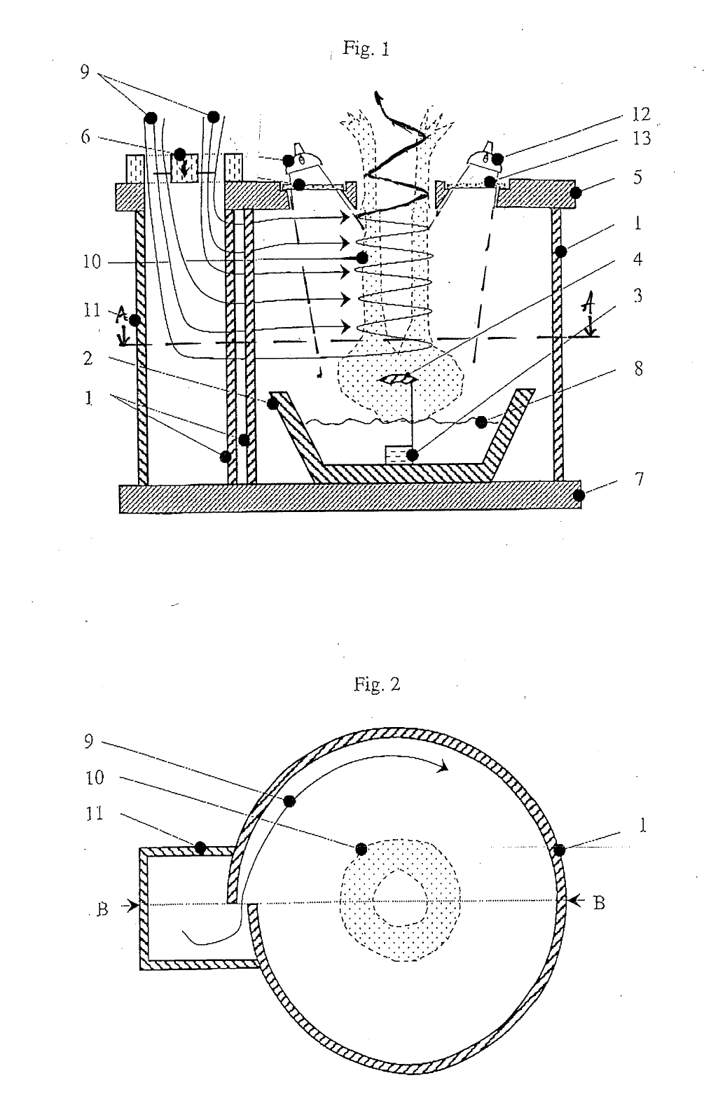

Beneficial designs of the invention are defined in the patent claims 1 to 8, that focus on different utilization purposes. These designs are subsequently described by means of FIGS. 1 to 6:

The embodiment of the invention according to patent claim 1 is shown in FIG. 1. The apparatus consists of a cylindrical, see-through whirl chamber (1) that features an air intake slit that stretches across the whole height of the cylinder. It also features a central exhaust opening in the lid (5). On the floor (7) of the whirl chamber, a bowl (2) with an ultrasonic mist generator (3) with splash guard (4) is placed. The bowl is filled with water (8). An air stream (9) is maintained by means of a fan (6) that is mounted to antechamber (11). The mist generated by the mist generator is forced into a whirling motion by the air stream and forms a mist whirl (10) that mimics the characteristics of a tornado. This basic design allows the invention to be used primarily as decorative household appliance for improving the indoor climate by adding water and small quantities of admixtures to the air.

The air stream (9) is distributed evenly across the whole axial length in order to prevent the mist to get into contact with the see-through whirl chamber walls (1).

The optical stimulus of the invention is heightened by illuminating the mist whirl (10) with white or colored light from tungsten-halogen reflectors (12) with exchangeable optical color filters (13).

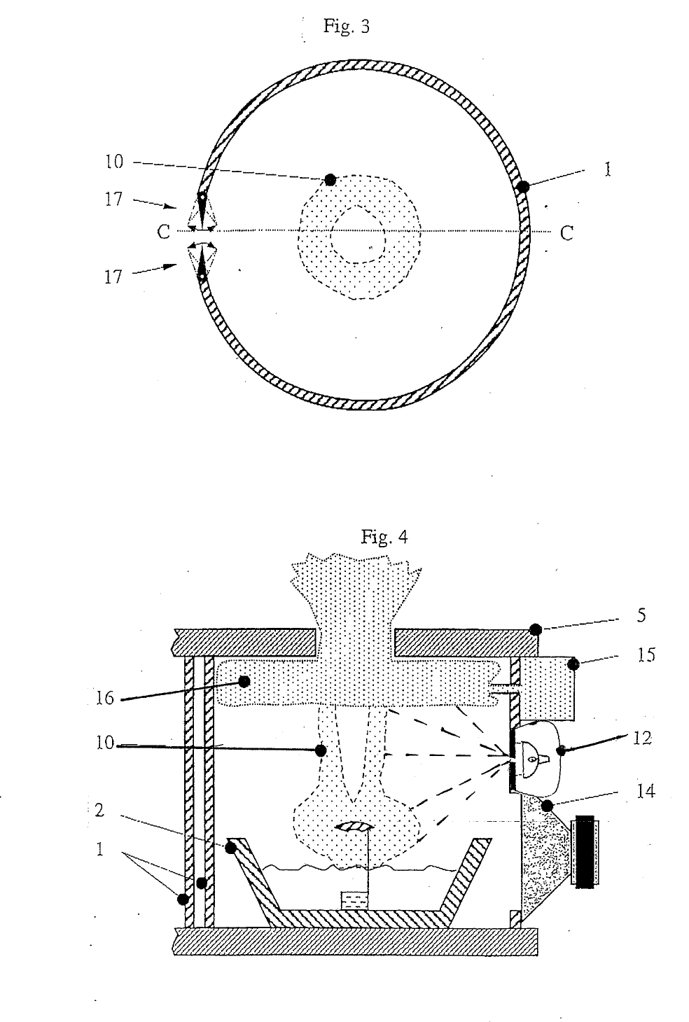

The embodiment of the invention according to FIG. 3. differs from embodiment FIG. 1 and FIG. 2 mostly by the whirl chamber being equipped with adjustable flaps (17) at the air intake, in order to control the speed and the direction of the whirl. The whirl speed also is controllable by adjusting the fan speed.

The embodiment of the invention according to FIG. 4 shows the illumination means being mounted to the side of the whirl chamber wall (1). A loudspeaker (14) and a second fog generator (15) are attached to the whirl chamber (1) as well. The speaker allows to modulate the outflow of air and with it the shape of the mist whirl (10). The fog generator evaporates a fog fluid that results in thick fog, filling out the upper part of the whirl chamber (16). The combined effect is a “dancing” tornado that emerges from a cloud deck. With additional strobe light illumination the illusion of a “tempest in a teacup” is perfected.

LED technology is another suitable means in order to create varying illumination effects.

The embodiment of the invention according to FIG. 5 features a permanent refilling station (40+41) for the whirl chamber. The water supply is constantly replenished to the optimum level through the connection tube (42), until the water tank (40) is empty. Even then the machine does not need to be turned off since the water tank is replaceable during the operation of the machine.

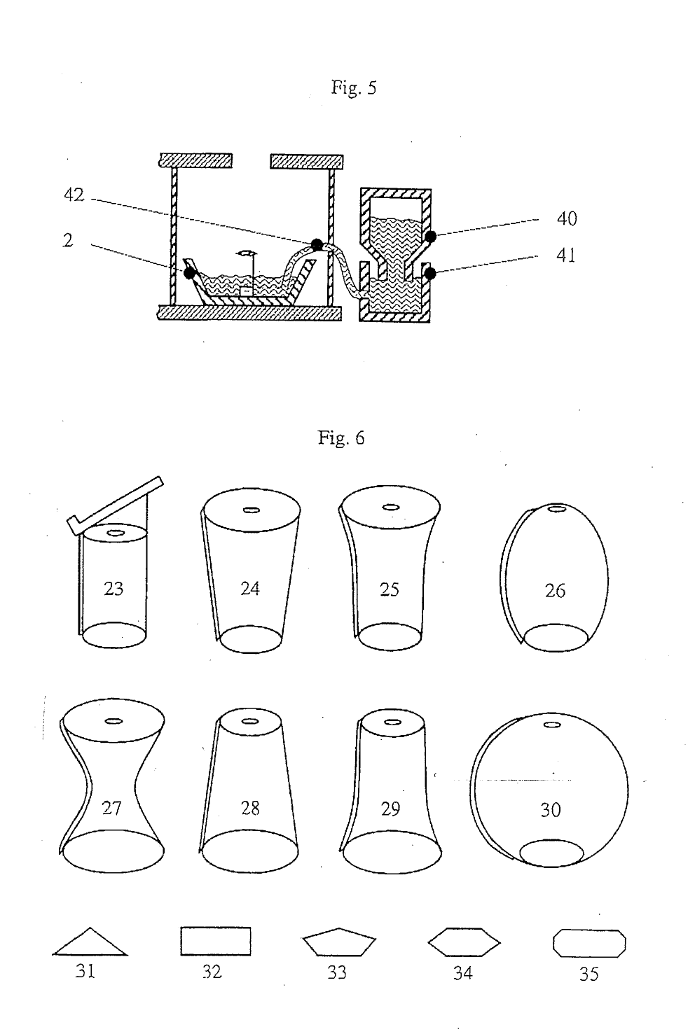

In FIG. 6 different geometric shapes feasible as whirl chamber are shown. In order to heighten the optical stimulus further, whirl chambers in various geometric shapes may be employed. Examples for feasible whirl chamber designs are shape 23: lectern, to shape 30: sphere. Besides a circle as footprint for shapes 23 to 30, various geometric surfaces, for example shapes 31 to 35, are suitable footprints as well. The whirl chamber layout is not limited to these shapes.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention, as defined in the appended claims.

What is claimed is:

1. The Tornado-Machine—A mist whirling apparatus that can be used as an ornamental display of light, as well as an air humidifier and as an aerosol generator, with a whirl chamber, which is fed air by a fan, and which features a chamber wall (1) with an air inlet, a floor (7) with an accompanying ultrasonic mist generator (3), and a lid (5) with central exhaust opening, and within the whirl chamber a circular air stream (9) is maintained, starting along the chamber wall, and then spiraling inwards, thereby embracing the mist generated by the mist generator and carrying it out of the chamber through the central exhaust opening in the lid (5), in a central mist whirl, of the type wherein
the whirl chamber wall (1) is made of a clear, see-through material
the air intake in the whirl chamber wall (1) distributes the inflowing air evenly across the whole axial length of the whirl chamber
the whirl chamber is equipped with illuminating means (12) that illuminate the mist whirl in the whirl chamber.

2. A mist whirling apparatus according to claim 1, wherein the air intake is stretching across the whole axial length of the whirl chamber wall (1).

3. A mist whirling apparatus according to claims 1 or 2, wherein the air intake is featuring adjustable flaps (17) for controlling speed and direction of the inflowing air stream.

4. A mist whirling apparatus according to claims 1 through 3, wherein the air intake is controlled by controlling the fan speed.

5. A mist whirling apparatus according to claim 1, wherein the illumination means (12) are equipped to modulate their light output in brightness and color in a controlled or random manner.

6. A mist whirling apparatus according to claim 1, wherein an additional fog generator is filling the part of the whirl chamber underneath the lid (5) with fog throughout the whole chamber diameter.

7. A mist whirling apparatus according to claim 1, wherein a loudspeaker (14) is connected to the whirl chamber in order to modulate the shape of the mist whirl (10).

8. A mist whirling apparatus according to claim 4, wherein the liquid of the whirl chamber is refilled by means of an electromechanically or gravitationally operated refilling station (40,41,42).
